(19) United States
(12) Patent Application Publication
(10) Pub. No.: US 2010/0288970 A1
(43) Pub. Date: Nov. 18, 2010

(54) NEGATIVE ELECTRODE MATERIAL FOR NONAQUEOUS ELECTROLYTE SECONDARY BATTERY, MAKING METHOD AND LITHIUM ION SECONDARY BATTERY

(76) Inventors: Koichiro WATANABE, Annaka-shi (JP); Meguru Kashida, Annaka-shi (JP); Hirofumi Fukuoka, Annaka-shi (JP)

Correspondence Address: BIRCH STEWART KOLASCH & BIRCH, PO BOX 747, FALLS CHURCH, VA, 22040-0747, US

(21) Appl. No.: 12/781,579

(22) Filed: May 17, 2010

(30) Foreign Application Priority Data
May 18, 2009 (JP) 2009-120058

(51) Int. Cl. H01M 4/02; H01M 4/04

(52) U.S. Cl. 252/182.1; 216/13

(57) ABSTRACT

A negative electrode material for nonaqueous electrolyte secondary batteries comprises composite particles which are prepared by coating surfaces of particles having silicon nano-particles dispersed in silicon oxide with a carbon coating, and etching the coated particles in an acidic atmosphere. The silicon nano-particles have a size of 1-100 nm. The composite particles contain oxygen and silicon in a molar ratio: O<O/Si<1.0. Using the negative electrode material, a lithium ion secondary battery can be fabricated which features a high 1st cycle charge/discharge efficiency, a high capacity, and improved cycle performance.

### CROSS-REFERENCE TO RELATED APPLICATION

This non-provisional application claims priority under 35 U.S.C. §119(a) on Patent Application No. 2009-120058 filed in Japan on May 18, 2009, the entire contents of which are hereby incorporated by reference.

### TECHNICAL FIELD

This invention generally relates to nonaqueous electrolyte secondary batteries, typically lithium ion secondary batteries. Specifically, it relates to negative electrode materials for use in such batteries and more particularly, to negative electrode materials having advantages of high 1st cycle charge/discharge efficiency, capacity and cycle performance when used as the negative electrode active material in lithium ion secondary batteries, and a method for preparing the same.

### BACKGROUND ART

In conjunction with the recent rapid advances of portable electronic equipment and communications instruments, nonaqueous electrolyte secondary batteries having a high energy density are strongly demanded from the aspects of cost, size and weight reductions. A number of measures are known in the art for increasing the capacity of such nonaqueous electrolyte secondary batteries. For example, JP 3008228 and JP 3242751 disclose negative electrode materials comprising oxides of B, Ti, V, Mn, Co, Fe, Ni, Cr, Nb, and Mo and composite oxides thereof. A negative electrode material comprising M₁₀₀₋ₓSiₓ wherein x≧50 at % and M=Ni, Fe, Co or Mn is obtained by quenching from the melt (JP 3846661). Other negative electrode materials are known as comprising silicon oxide (JP 2997741), and Si₂N₂O, Ge₂N₂O or Sn₂N₂O (JP 3918311).

Among others, silicon oxide is represented by SiOₓ wherein x is slightly greater than the theory of 1 due to oxide coating, and is found on X-ray diffractometry analysis to have the structure that nano-size silicon ranging from several to several tens of nanometers is finely dispersed in silicon oxide. The battery capacity of silicon oxide is smaller than that of silicon, but greater than that of carbon by a factor of 5 to 6 on a weight basis. Silicon oxide experiences a relatively less volume expansion. Silicon oxide is thus believed ready for use as the negative electrode active material. Nevertheless, silicon oxide has a substantial irreversible capacity and a very low initial efficiency of about 70%, which requires an extra battery capacity of the positive electrode when a battery is actually fabricated. Then an increase of battery capacity corresponding to the 5 to 6-fold capacity increase per active material weight is not expectable.

The problem of silicon oxide to be overcome prior to practical use is a substantially low initial efficiency. This may be overcome by making up the irreversible fraction of capacity or by restraining the irreversible capacity. The method of making up the irreversible fraction of capacity by previously doping silicon oxide with Li metal is reported effective. Doping of lithium metal may be carried out by attaching a lithium foil to a surface of negative electrode active material (JP-A 11-086847) or by vapor depositing lithium on a surface of negative electrode active material (JP-A 2007-122992). As for the attachment of a lithium foil, a thin lithium foil that matches with the initial efficiency of silicon oxide negative electrode is hardly available or prohibitively expensive if available. The deposition of lithium vapor makes the fabrication process complex and is impractical.

Aside from lithium doping, it is also disclosed to enhance the initial efficiency of negative electrode by increasing a weight proportion of silicon. One method is by adding silicon particles to silicon oxide particles to reduce the weight proportion of silicon oxide (JP 3982230). In another method, silicon vapor is generated and precipitated in the same stage as is produced silicon oxide, obtaining mixed solids of silicon and silicon oxide (JP-A 2007-290919). Silicon has both a high initial efficiency and a high battery capacity as compared with silicon oxide, but displays a percent volume expansion as high as 400% upon charging. Even when silicon is added to a mixture of silicon oxide and carbonaceous material, the percent volume expansion of silicon oxide is not maintained, and eventually at least 20 wt % of carbonaceous material must be added in order to suppress the battery capacity at 1,000 mAh/g. The method of obtaining the mixed solids by simultaneously generating silicon and silicon oxide vapors suffers from the working problem that the low vapor pressure of silicon necessitates the process at a high temperature in excess of 2,000° C.

### CITATION LIST

Patent Document 1: JP 3008228

Patent Document 2: JP 3242751

Patent Document 3: JP 3846661

Patent Document 4: JP 2997741

Patent Document 5: JP 3918311

Patent Document 6: JP-A 11-086847

Patent Document 7: JP-A 2007-122992

Patent Document 8: JP 3982230

Patent Document 9: JP-A 2007-290919

### SUMMARY OF INVENTION

An object of the invention is to provide a negative electrode material for use in non-aqueous electrolyte secondary batteries, which exhibits a high 1st cycle charge/discharge efficiency and improved cycle performance while maintaining the high battery capacity and low volume expansion of silicon oxide. Another object is to provide a method for preparing the negative electrode material and a lithium ion secondary battery using the same.

The inventors made efforts to search for a silicon base active material for non-aqueous electrolyte secondary battery negative electrodes which has a high battery capacity surpassing carbonaceous materials, minimizes a change of volume expansion inherent to silicon based negative electrode active materials, and overcomes silicon oxide's drawback of a lowering of 1st cycle charge/discharge efficiency. As a result, the inventors found that when particles (represented by SiOₓ) having silicon nano-particles dispersed in silicon oxide are used as the negative electrode active material, oxygen in the silicon oxide reacts with lithium ion to form irreversible Li₄SiO₄, which causes a lowering of 1st cycle charge/discharge efficiency. That is, the negative electrode material obtained by adding silicon particles to silicon oxide particles as described in the preamble entails an eventual reduction of apparent oxygen content and results in an improvement in 1st cycle charge/discharge efficiency. However, even when silicon particles having selected physical properties are added, the electrode experiences a substantial volume expansion upon charging and an extreme drop of cycle performance. The inventors have found that by etching particles having silicon nano-particles of 1 to 100 nm size dispersed in silicon oxide in an acidic atmosphere, silicon dioxide can be selectively removed from the particles such that the resultant particles may contain oxygen and silicon in a molar ratio from more than 0 to less than 1.0. A negative electrode material comprising the resultant particles as the active material may be used to construct a nonaqueous electrolyte secondary battery having improved 1st cycle charge/discharge efficiency, a high capacity, and improved cycle performance. The invention is predicated on this finding.

In one aspect, the invention provides a negative electrode material for nonaqueous electrolyte secondary batteries, comprising composite particles which are prepared by coating surfaces of particles having silicon nano-particles dispersed in silicon oxide with a carbon coating and etching the coated particles in an acidic atmosphere, wherein the silicon nano-particles have a size of 1 to 100 nm and a molar ratio of oxygen to silicon is from more than 0 to less than 1.0.

In a preferred embodiment, the composite particles have an average particle size of 0.1 to 50 μm and a BET specific surface area of 0.5 to 100 m²/g. In a preferred embodiment, the carbon coating is formed by chemical vapor deposition.

In another aspect, the invention provides a lithium ion secondary battery comprising the negative electrode material defined above.

In a further aspect, the invention provides a method of preparing a negative electrode material comprising composite particles for nonaqueous electrolyte secondary batteries, comprising the steps of: (I) effecting chemical vapor deposition of carbon on silicon oxide particles prior to disproportionation reaction or particles having silicon nano-particles dispersed in silicon oxide to form coated particles which are surface coated with carbon and have silicon nano-particles with a size of 1 to 100 nm dispersed in silicon oxide, and (II) etching the coated particles in an acidic atmosphere to form the composite particles.

### ADVANTAGEOUS EFFECTS OF INVENTION

Using the negative electrode material of the invention, a nonaqueous electrolyte secondary battery can be fabricated which features a high 1st cycle charge/discharge efficiency, a high capacity, and improved cycle performance. The method for preparing the negative electrode material is simple and amenable to manufacture in an industrial scale.

### DESCRIPTION OF EMBODIMENTS

The negative electrode material for use in nonaqueous electrolyte secondary batteries according to the invention comprises composite particles which are prepared by coating surfaces of particles having silicon nano-particles dispersed in silicon oxide with a carbon coating, and etching the coated particles in an acidic atmosphere. The silicon nano-particles have a size of 1 to 100 nm. A molar ratio of oxygen to silicon is from more than 0 to less than 1.0.

The particles having silicon nano-particles of 1 to 100 nm size dispersed in silicon oxide may be obtained by any desired methods, for example, by firing a mixture of fine particulate silicon and a silicon compound, or by heat treating silicon oxide particles of the formula: SiOₓ(wherein 1.0≦x≦1.10) prior to disproportionation in an inert non-oxidizing atmosphere of argon or the like, preferably at a temperature from more than 700° C. to 1,200° C., for effecting disproportionation reaction. Outside the range, too low a temperature may result in crystals of smaller size whereas too high a temperature may promote excess growth of crystals.

As used herein, the term “silicon oxide” generally refers to amorphous silicon oxides which are produced by heating a mixture of silicon dioxide and metallic silicon to produce silicon monoxide gas and cooling the gas for precipitation. Silicon oxide prior to disproportionation reaction is represented by the general formula SiOₓ wherein x is in the range: 1.0≦x≦1.10.

The silicon oxide prior to disproportionation reaction and the particles having silicon nano-particles dispersed in silicon oxide have physical properties (e.g., particle size and surface area) which may be properly selected in accordance with the desired composite particles. For example, an average particle size of 0.1 to 50 μm is preferred. The lower limit of average particle size is more preferably at least 0.2 μm, and even more preferably at least 0.5 μm while the upper limit is more preferably up to 30 μm, and even more preferably up to 20 μm. As used herein, the “average particle size” refers to a weight average particle size in particle size distribution measurement by the laser light diffraction method. Also a BET specific surface area of 0.5 to 100 m²/g is preferred, with a range of 1 to 20 m²/g being more preferred.

### Coated Particles

Carbon coating is applied to impart conductivity to the negative electrode material. Coating with carbon may be preferably performed by subjecting a mixture of fine particulate silicon and a silicon compound, silicon oxide particles having the general formula SiOₓ (wherein 1.0≦x≦1.10) prior to disproportionation, or particles having silicon nano-particles dispersed in silicon oxide to chemical vapor deposition (CVD). This may be achieved at a higher efficiency by feeding an organic compound gas into the reactor during heat treatment. When the treatment is performed at high temperature, disproportionation reaction can simultaneously take place, resulting in the process being simplified.

Specifically, carbon-coated particles are obtained by subjecting a mixture of fine particulate silicon and a silicon compound, silicon oxide particles having the general formula SiOₓ (wherein 1.0≦x≦1.10) prior to disproportionation, or particles having silicon nano-particles dispersed in silicon oxide to CVD in an organic compound gas at a reduced pressure of 50 to 30,000 Pa and a temperature of 800 to 1,300° C. Carbon-coated particles obtained from the silicon oxide particles prior to disproportionation are especially preferred because fine crystals of silicon are uniformly dispersed therein. The pressure during CVD is preferably in a range of 50 to 10,000 Pa, more preferably 50 to 2,000 Pa. If CVD is under a pressure in excess of 30,000 Pa, the coated material may have a more fraction of graphitic material having graphite structure, leading to a reduced battery capacity and degraded cycle performance when used as the negative electrode material in nonaqueous electrolyte secondary batteries. The CVD temperature is preferably in a range of 800 to 1,200° C., more preferably 900 to 1,100° C. At a temperature below 800° C., the growth of silicon nano-particles may be short, which may interfere with the subsequent etching treatment. A temperature above 1,200° C. may cause fusion and agglomeration of particles during CVD treatment. Since a conductive coating is not formed at the agglomerated interface, the resulting material may suffer from degraded cycle performance when used as the negative electrode material in nonaqueous electrolyte secondary batteries. Although the treatment time may be suitably determined in accordance with the desired carbon coverage, treatment temperature, concentration (flow rate) and quantity of organic compound gas, and the like, a time of 1 to 10 hours, especially 2 to 7 hours is cost effective.

The organic compound used to generate the organic compound gas is a compound which is thermally decomposed, typically in a non-acidic atmosphere, at the heat treatment temperature to form carbon or graphite. Exemplary organic compounds include hydrocarbons such as methane, ethane, ethylene, acetylene, propane, butane, butene, pentane, isobutane, and hexane, alone or in admixture, mono- to tri-cyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene, alone or in admixture, and mixtures of the foregoing. Also, gas light oil, creosote oil and anthracene oil obtained from the tar distillation step are useful as well as naphtha cracked tar oil, alone or in admixture.

In the carbon-coated particles, the coverage (or coating weight) of carbon is preferably 0.3 to 40%, and more preferably 0.5 to 30% by weight, but not limited thereto. A carbon coverage of less than 0.3 wt % may fail to impart satisfactory conductivity, leading to degraded cycle performance when used as the negative electrode material in nonaqueous electrolyte secondary batteries. A carbon coverage of more than 40 wt % may achieve no further effect and correspond to a larger fraction of graphite in the negative electrode material, leading to a reduced charge/discharge capacity when used as the negative electrode material in nonaqueous electrolyte secondary batteries.

In the coated particles, the silicon nano-particles have a size of 1 to 100 nm and preferably 3 to 10 nm. If the size of silicon nano-particles is too small, recovery after etching is difficult. Silicon nano-particles of too large size may adversely affect the cycle performance. The size may be modified by controlling the temperature of disproportionation reaction, CVD treatment, and the like. If the temperature is too low or too high, then crystals may become of smaller or larger size. The size may be measured under a transmission electron microscope (TEM).

### Etching Treatment

The coated particles are then etched in an acidic atmosphere, whereby silicon dioxide can be selectively removed from the particles such that the resultant particles (i.e., composite particles) may contain oxygen and silicon in a molar ratio: 0<O/Si<1.0.

The acidic atmosphere may be either an acidic aqueous solution or an acid-containing gas while its composition is not particularly limited. Suitable acids used herein include hydrogen fluoride, hydrochloric acid, nitric acid, hydrogen peroxide, sulfuric acid, acetic acid, phosphoric acid, chromic acid, and pyrophosphoric acid, which may be used alone or in admixture of two or more, with hydrogen fluoride being preferred. The term “etching” means that the coated particles are treated with an acidic aqueous solution or an acidic gas, both containing an acid as mentioned just above. Treatment with an acidic aqueous solution may be performed by agitating the coated particles in an acidic aqueous solution. Treatment with an acid-containing gas may be performed by charging a reactor with the coated particles, feeding an acid-containing gas into the reactor, and treating the particles in the reactor. The acid concentration and treatment time may be suitably selected depending on the desired etching level. The treatment temperature is not particularly limited although a temperature of 0° C. to 1,200° C., especially 0° C. to 1,100° C. is preferred. A temperature in excess of 1,200° C. may promote excess growth of silicon crystals in the particles having silicon nano-particles dispersed in silicon oxide, leading to a reduced capacity. The amount of the acid used relative to the coated particles may be suitably determined and adjusted depending on the type and concentration of acid and treatment temperature such that the resultant particles may contain oxygen and silicon in a molar ratio: 0<0/Si<1.0.

### Composite Particles

The composite particles are prepared by providing particles having silicon nano-particles dispersed in silicon oxide, surface coating the particles with a carbon coating, and etching the coated particles in an acidic atmosphere. The silicon nano-particles have a size of 1 to 100 nm. A molar ratio of oxygen to silicon is from more than 0 to less than 1.0. If O/Si≦1.0, no satisfactory etching effect is exerted. In too low a molar ratio, substantial expansion may occur upon charging. The preferred molar ratio is 0.5<O/Si<0.9.

By etching coated particles in an acidic atmosphere, silicon dioxide can be selectively removed from the particles having silicon nano-particles or core particles of 1 to 100 nm size dispersed in silicon oxide. The resulting composite particles maintain the structure in which silicon nano-particles are dispersed in silicon oxide and have a carbon coating on their surface. Although the carbon coating has been subjected to etching treatment in an acidic atmosphere, the surface of the composite particles remains carbon-coated.

In the composite particles, the silicon nano-particles have a size of 1 to 100 nm and preferably 3 to 10 nm. If the size of silicon nano-particles is too small, recovery after etching is difficult. Silicon nano-particles of too large size may adversely affect the cycle performance. The size may be measured under TEM.

The composite particles have physical properties which are not particularly limited. For example, an average particle size of 0.1 to 50 μm is preferred. The lower limit of average particle size is more preferably at least 0.2 μm and even more preferably at least 0.5 μm while the upper limit is more preferably up to 30 μm and even more preferably up to 20 μm. Particles with an average particle size of less than 0.1 μm have a greater specific surface area and may contain a higher fraction of silicon dioxide on particle surfaces, leading to a loss of battery capacity when used as the negative electrode material in nonaqueous electrolyte secondary batteries. Particles with an average particle size of more than 50 μm may become foreign matter when coated as an electrode, leading to degraded battery properties. As used herein, the “average particle size” refers to a weight average particle size in particle size distribution measurement by the laser light diffraction method.

Also a BET specific surface area of 0.5 to 100 m²/g is preferred, with a range of 1 to 20 m²/g being more preferred. Particles with a surface area of less than 0.5 m²/g may be less adherent when coated as an electrode, leading to degraded battery properties. Particles with a surface area of more than 100 m²/g may contain a higher fraction of silicon dioxide on particle surfaces, leading to a loss of battery capacity when used as the negative electrode material in lithium ion secondary batteries.

The composite particles have a carbon coverage which is preferably 0.3 to 40%, and more preferably 0.5 to 30% by weight based on the composite particles, but not limited thereto. A carbon coverage of less than 0.3 wt % may fail to impart satisfactory conductivity, leading to degraded cycle performance when used as the negative electrode material in nonaqueous electrolyte secondary batteries. A carbon coverage of more than 40 wt % may achieve no further effect and correspond to a larger fraction of graphite in the negative electrode material, leading to a reduced charge/discharge capacity when used as the negative electrode material in nonaqueous electrolyte secondary batteries. Because the carbon coverage changes before and after etching treatment, the initial carbon coverage should be adjusted so as to provide the desired carbon coverage after the etching treatment.

### Negative Electrode Material

Disclosed herein is a negative electrode material for nonaqueous electrolyte secondary batteries, comprising the composite particles as an active material. A negative electrode may be prepared using the negative electrode material, and a lithium ion secondary battery may be constructed using the negative electrode.

When a negative electrode is prepared using the negative electrode material, a conductive agent such as carbon or graphite may also be added to the material. The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

From the negative electrode material, a negative electrode (shaped form) may be prepared, for example, by the following procedure. The negative electrode is prepared by combining the composite particles and optional additives such as conductive agent and binder, kneading them in a solvent such as N-methylpyrrolidone or water to form a paste-like mix, and applying the mix in sheet form to a current collector. The current collector used herein may be a foil of any material which is commonly used as the negative electrode current collector, for example, a copper or nickel foil while the thickness and surface treatment thereof are not particularly limited. The method of shaping or molding the mix into a sheet is not limited, and any well-known method may be used.

Lithium Ion Secondary Battery

The lithium ion secondary battery is characterized by the use of the negative electrode material while the materials of the positive electrode, negative electrode, electrolyte, and separator and the battery design may be well-known ones and are not particularly limited. For example, the positive electrode active material used herein may be selected from transition metal oxides such as LiCoO₂, LiNiO₂, LiMn₂O₄, V₂O₅, MnO₂, TiS₂ and MoS₂, lithium, and chalcogen compounds. The electrolytes used herein may be lithium salts such as lithium hexafluorophosphate and lithium perchlorate in nonaqueous solution form. Examples of the nonaqueous solvent include propylene carbonate, ethylene carbonate, diethyl carbonate, dimethoxyethane, γ-butyrolactone and 2-methyltetrahydrofuran, alone or in admixture. Use may also be made of other various non-aqueous electrolytes and solid electrolytes.

### Electrochemical Capacitor

The inventive composite particles may also be used for electrochemical capacitors. The electrochemical capacitor is characterized by comprising the negative electrode material described above, while other materials such as electrolyte and separator and capacitor design are not particularly limited. Examples of the electrolyte used include nonaqueous solutions of lithium salts such as lithium hexafluorophosphate, lithium perchlorate, lithium borofluoride, and lithium hexafluoroarsenate, and exemplary nonaqueous solvents include propylene carbonate, ethylene carbonate, dimethyl carbonate, diethyl carbonate, dimethoxyethane, γ-butyrolactone, and 2-methyltetrahydrofuran, alone or a combination of two or more. Other various nonaqueous electrolytes and solid electrolytes may also be used.

### EXAMPLE

Examples of the invention are given below by way of illustration and not by way of limitation.

### Preparation of Coated Particles

A batchwise heating furnace was charged with 300 g of particles of SiOₓ (x=1.01) having an average particle size of 5 μm and a BET specific surface area of 3.5 m²/g. The furnace was evacuated to vacuum by means of an oil sealed rotary vacuum pump while it was heated to 1,100° C. Once the temperature was reached, CH₄ gas was fed at 0.3 NL/min through the furnace where carbon coating treatment was carried out for 5 hours. A reduced pressure of 800 Pa was kept during the treatment. At the end of treatment, the furnace was cooled down, recovering 333 g of black particles (coated particles). The black particles had an average particle size of 5.2 μm and a BET specific surface area of 7.9 m²/g, and were conductive due to a carbon coverage of 9.9 wt % based on the black particles. On cross-sectional observation under TEM, the black particles were found to have the structure in which silicon nano-particles were dispersed in silicon oxide and had a size of 5 nm.

### Example 1

At room temperature, 50 g of the resulting black particles (coated particles) was fed into a 2-L plastic bottle to which 200 g of isopropyl alcohol was added. After the entire powder was contacted and infiltrated with isopropyl alcohol, 5 mL of 50 wt % hydrofluoric acid aqueous solution was gently added and stirred. The mixture had a hydrofluoric acid concentration of 1.2 wt % or contained 2.5 g of hydrogen fluoride relative to 50 g of the particles (5 parts by weight of hydrogen fluoride per 100 parts by weight of the particles).

The mixture was allowed to stand at room temperature for one hour, after which it was washed with deionized water, filtered, and dried in vacuum at 120° C. for 5 hours, obtaining 46.3 g of particles having an average particle size of 5.2 μm and a BET specific surface area of 9.7 m²/g. The carbon coverage was 10.7 wt % based on the particles. Using an analyzer EMGA-920 by Horiba Mfg. Co., Ltd., the particles were measured to have an oxygen concentration of 28.8 wt %, indicating an oxygen/silicon molar ratio of 0.84.

### Cell Test

The effectiveness of particles as a negative electrode material was evaluated by the following cell test. The particles, 90 wt %, were combined with 10 wt % of polyimide. Then N-methylpyrrolidone was added to the mixture to form a slurry. The slurry was coated onto a copper foil of 12 μm thick and dried at 80° C. for one hour. Using a roller press, the coated foil was shaped under pressure into an electrode sheet. The electrode sheet was vacuum dried at 350° C. for 1 hour, after which pieces of 2 cm² were punched out as the negative electrode.

To evaluate the charge/discharge characteristics of the piece as the negative electrode, a test lithium ion secondary cell was constructed using a lithium foil as the counter electrode. The electrolyte solution used was a nonaqueous electrolyte solution of lithium hexafluorophosphate in a 1/1 (by volume) mixture of ethylene carbonate and diethyl carbonate in a concentration of 1 mol/liter. The separator used was a porous polyethylene film of 30 μm thick.

The lithium ion secondary cell thus constructed was allowed to stand overnight at room temperature. Using a secondary cell charge/discharge tester (Nagano K.K.), a charge/discharge test was carried out on the cell. Charging was conducted with a constant current flow of 0.5 mA/cm² until the voltage of the test cell reached 0 V, and after reaching 0 V, continued with a reduced current flow so that the cell voltage was kept at 0 V, and terminated when the current flow decreased below 40 μA/cm². Discharging was conducted with a constant current flow of 0.5 mA/cm² and terminated when the cell voltage reached 1.4 V, from which a discharge capacity was determined.

By repeating the above operation, the charge/discharge test was carried out 50 cycles on the lithium ion secondary cell. The cell marked an initial (1st cycle) charge capacity of 2,160 mAh/g, an initial discharge capacity of 1,793 mAh/g, an initial charge/discharge efficiency of 83.0%, a 50-th cycle discharge capacity of 1,578 mAh/g, and a cycle retentivity of 88% after 50 cycles, indicating a high capacity. It was a lithium ion secondary cell having improved 1st cycle charge/discharge efficiency and cycle performance.

### Example 2

The black particles (coated particles) in Example 1 were treated as in Example 1 expect that the mixture had a hydrofluoric acid concentration of 10 wt % or contained 25 g of hydrogen fluoride relative to 50 g of the particles (50 parts by weight of hydrogen fluoride per 100 parts by weight of the particles). The resulting black particles had a carbon coverage of 12.1 wt %, an oxygen concentration of 24.5 wt % indicating an oxygen/silicon molar ratio of 0.75, an average particle size of 5.1 μm, and a BET specific surface area of 17.6 m²/g.

As in Example 1, a negative electrode was prepared and evaluated by a cell test. The cell marked an initial charge capacity of 2,220 mAh/g, an initial discharge capacity of 1,863 mAh/g, an initial charge/discharge efficiency of 83.9%, a 50-th cycle discharge capacity of 1,602 mAh/g, and a cycle retentivity of 86% after 50 cycles, indicating a high capacity. It was a lithium ion secondary cell having improved 1st cycle charge/discharge efficiency and cycle performance.

### Example 3

At room temperature, a stainless steel chamber was charged with 50 g of the black particles (coated particles) in Example 1. Hydrogen fluoride gas diluted to 40% by volume with nitrogen was flowed through the chamber for 1 hour. After the hydrogen fluoride gas flow was interrupted, the chamber was purged with nitrogen gas until the HF concentration of the outgoing gas as monitored by a FT-IR monitor decreased below 5 ppm. Thereafter, the particles were taken out, which weighed 46.7 g and had a carbon coverage of 10.6 wt %, an average particle size of 5.2 μm, a BET specific surface area of 9.5 m²/g, and an oxygen concentration of 29.2 wt %, indicating an oxygen/silicon molar ratio of 0.84.

As in Example 1, a negative electrode was prepared and evaluated by a cell test. The cell marked an initial charge capacity of 2,150 mAh/g, an initial discharge capacity of 1,774 mAh/g, an initial charge/discharge efficiency of 82.5%, a 50-th cycle discharge capacity of 1,590 mAh/g, and a cycle retentivity of 90% after 50 cycles, indicating a high capacity. It was a lithium ion secondary cell having improved 1st cycle charge/discharge efficiency and cycle performance.

### Comparative Example 1

As in Example 1, a negative electrode was prepared using the black particles (coated particles) in Example 1 as such (without etching treatment) and evaluated by a cell test. The cell marked an initial charge capacity of 1,994 mAh/g, an initial discharge capacity of 1,589 mAh/g, an initial charge/discharge efficiency of 79.7%, a 50-th cycle discharge capacity of 1,428 mAh/g, and a cycle retentivity of 90% after 50 cycles. This lithium ion secondary cell was apparently inferior in discharge capacity and 1st cycle charge/discharge efficiency to Example 1.

### Comparative Example 2

A batchwise heating furnace was charged with 300 g of particles of SiOₓ (x=1.01) having an average particle size of 5 μm and a BET specific surface area of 3.5 m²/g. The furnace was evacuated to vacuum by means of an oil sealed rotary vacuum pump while it was heated to 700° C. Once the temperature was reached, C₂H₄ gas was fed at 0.2 NL/min through the furnace where carbon coating treatment was carried out for 5 hours. A reduced pressure of 800 Pa was kept during the treatment. At the end of treatment, the furnace was cooled down, recovering 337 g of charcoal gray particles. The charcoal gray particles had an average particle size of 5.2 μm and a BET specific surface area of 2.4 m²/g, and were conductive due to a carbon coverage of 11.0 wt % based on the charcoal gray particles. On cross-sectional observation under TEM, the particles were found to have the structure in which silicon nano-particles were dispersed in silicon oxide and had a size of 0.9 nm.

The resulting particles, 50 g, were subjected to etching treatment with a hydrofluoric acid aqueous solution having a hydrofluoric acid concentration of 1.1 wt % as in Example 1 (without heat treatment). The mixture was allowed to stand, and similarly washed and filtered. Since particles were recovered in a very low yield of 20%, the process was not regarded practically acceptable.

TABLE 1

| | | BET specific | | | | Retentivity |
|---|---|---|---|---|---|---|
| | O/Si | surface area, | Initial charge | Initial discharge | Initial efficiency, | after 50 cycles, |
| | molar ratio | m²/g | capacity, mAh/g | capacity, mAh/g | % | % |
| Example 1 | 0.84 | 9.7 | 2160 | 1793 | 83.0 | 88 |
| Example 2 | 0.75 | 17.6 | 2220 | 1863 | 83.9 | 86 |
| Example 3 | 0.84 | 9.5 | 2150 | 1774 | 82.5 | 90 |
| Comparative | 1.01 | 7.9 | 1994 | 1589 | 79.7 | 90 |
| Example 1 | | | | | | |

Japanese Patent Application No. 2009-120058 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A negative electrode material for nonaqueous electrolyte secondary batteries, comprising composite particles which are prepared by coating surfaces of particles having silicon nano-particles dispersed in silicon oxide with a carbon coating and etching the coated particles in an acidic atmosphere, wherein the silicon nano-particles have a size of 1 to 100 nm and a molar ratio of oxygen to silicon is from more than 0 to less than 1.0.

2. The negative electrode material of claim 1 wherein the composite particles have an average particle size of 0.1 to 50 μm and a BET specific surface area of 0.5 to 100 m²/g.

3. The negative electrode material of claim 1 wherein the carbon coating is formed by chemical vapor deposition.

4. A lithium ion secondary battery comprising the negative electrode material of claim 1.

5. A method of preparing a negative electrode material comprising composite particles, for use in nonaqueous electrolyte secondary batteries, comprising the steps of:
(I) effecting chemical vapor deposition of carbon on silicon oxide particles prior to disproportionation reaction or particles having silicon nano-particles dispersed in silicon oxide to form coated particles which are surface coated with carbon and have silicon nano-particles with a size of 1 to 100 nm dispersed in silicon oxide, and
(II) etching the coated particles in an acidic atmosphere to form the composite particles.
